(19) United States
(12) Patent Application Publication
(10) Pub. No.: US 2024/0124737 A1
(43) Pub. Date: Apr. 18, 2024

(54) A METHOD OF IMPROVING WATER WASHOUT RESISTANCE OF AN EXTERIOR COATING COMPOSITION AND EXTERIOR COATING COMPOSITIONS HAVING IMPROVED WATER WASHOUT RESISTANCE

(71) Applicant: Dow Global Technologies LLC, Midland, MI (US)

(72) Inventors: Debora Ressnig, Zuerich (CH); Jouko Vyorykka, Waedenswil (CH)

(21) Appl. No.: 18/262,030

(22) PCT Filed: Apr. 7, 2021
(86) PCT No.: PCT/US2021/026092

§ 371 Date: Jul. 19, 2023

(51) Int. Cl. C09D 133/08; C09D 7/43

(52) U.S. Cl. CPC C09D 133/08; C09D 7/43

(57) ABSTRACT

An exterior coating composition and method of using said coating to coat an exterior surface, the composition comprising: an aqueous emulsion of acrylic polymer, and at least one branched cellulose ether, wherein the branched cellulose ether has a viscosity of at least 6000 mPa·s in a 1% wt. % aqueous solution with a shear rate of 2.55 s⁻¹ at 20° C. and an active addition weight percentage of 0.1% to 2.0% of the exterior coating composition.

### FIELD OF THE INVENTION

The present disclosure relates to a method of reducing the drying time of an exterior coating composition, a use of branched cellulose ether in reducing the drying time of an exterior coating composition and exterior coating compositions having reduced drying time and early development of resistance against water washout; for example, water washout from rain water.

### INTRODUCTION

Traditional exterior coatings may be destroyed and/or washed off in the event of early rain or other water exposure (e.g., within 24 hours after application). Applicators may therefore not take the risk of applying the coating with an uncertain weather forecast, which results in lower productivity on construction site and costly delays. The time before rain resistance sets-in can also be delayed by compounding various factors such as high humidity or lower temperatures.

Cellulose ethers are employed in various water-based exterior coating applications as rheology modifiers to appropriately thicken the coating. Proper viscosity of the wet coating formulation is required for successful application to the substrate, and the viscosity may be tailored to be suitable for any of the known application methods, such as spraying, rolling, troweling, brushing. However, cellulose ethers pose drawbacks as highly viscous cellulose ethers, those with a viscosity level of above 60000 mPa·s (Viscotester VT550 by Thermo Haake, Thermo Fisher Scientific, USA), 2 wt. % aq. solution, 2.55 s⁻¹ at 20° C.), are difficult to access because of the difficulty in sourcing and processing raw material (pulp). Highly viscous cellulose ethers also present challenges when formulating the coating as they rate of dissolution is excessive and above the practical limits for preparation, meaning these require excessive mixing durations to disperse. Inadequate dissolution of the cellulose ether rheology modifier will result in numerous coating deficiency issues such as settling, compaction, or grit that results in visual blemishes or can clog spray nozzles. The modified cellulose ethers of the present invention contain chemically bound polyoxyalkylene branches which enhance the wettability of the granulated cellulose ether particles. The polyoxyalkylene branches facilitate the particle breakup and dissolution of the granular rheology modifier. Compared to conventional linear (unbranched) cellulose ether rheology modifiers, the enhanced wetting of the branched cellulose ethers enables smoother formulations at molecular weights and rheology response than is practical for the conventional linear cellulose ether rheology modifiers.

### SUMMARY

Embodiments relate to wet-coating compositions containing acrylic dispersion binders, methods of manufacturing such compositions, and methods of using said compositions. These end uses may include, but are not limited to, organic renders (e.g., external thermal insulation composite system (ETICS)) used for wall coatings, elastomeric roof-coatings (ERC) and/or paint coatings. The composition may be described as a water-based coating formulation in combination with a modified water-soluble cellulose ether, specifically a branched cellulose such as those described in U.S. Pat. No. 10,150,704B2. The modified cellulose ether may be prepared by crosslinking reactions with diepoxy polyethers. It has been found that these ethers surprisingly enhance the set time of exterior coating compositions, which has the benefit of providing earlier resistance to water which prevents washout.

This effect was shown to be improved versus conventional cellulose ethers or other synthetic rheology modifiers. The use of the modified cellulose ethers in an exterior coating composition offers various additional advantages including reduced rheology modifier demand and enhanced coating water washout resistance.

In one specific embodiment, branched cellulose ethers containing polyether groups are utilized as rheology modifiers in an exterior coating formulation. A branched cellulose ether is a cellulose ether that has been chemically modified using bis-epoxy polyethers crosslinking agents. This modified cellulose ether composition maintains sufficient water solubility to act as a rheology modifier (as opposed to a crosslinked cellulose ether, which are used as water-retention agents used in cements or mortars, and which also provide no thickening effect).

In accordance with the exterior coating composition and method of using the exterior coating composition of the present invention, at least one of the one or more branched cellulose ethers is the crosslinked reaction product of a crosslinked cellulose ether which, absent crosslinking, would have a viscosity of from 10,000 to 80,0000, or preferably 30,000 to 70,000 mPa·s measured as a 2 wt. % solution in water using a rotational viscometer (Viscotester™ VT550 by Thermo Haake™, Thermo Fisher Scientific, USA) at 20° C. and a shear rate 2.55 s⁻¹.

In accordance with the exterior coating composition and method of using the exterior coating composition of the present invention, at least one of the one or more branched cellulose ethers is chosen from a non-mixed cellulose ether that contains alkyl ether groups, or a mixed cellulose ether that contains hydroxyalkyl groups and alkyl ether groups, such as those chosen from alkyl hydroxyethyl celluloses, e.g. hydroxyalkyl methylcelluloses, and is, preferably, chosen from hydroxyethyl methylcellulose (HEMC), hydroxypropyl methylcellulose (HPMC), methyl hydroxyethyl hydroxypropylcellulose (MHEHPC), methyl ethyl hydroxyethyl cellulose (MEHEC) and ethylhydroxyethyl cellulose (EHEC), or, more preferably, HEMC.

The polyether group of the branched cellulose ether of the present invention used in the exterior coating composition and method of using the exterior coating composition is a polyoxyalkylene which has from 2 to 100 or, preferably, 2 to 20, or, more preferably, from 3 to 15 oxyalkylene groups.

In accordance with the exterior coating composition and method of using the exterior coating composition of the present invention, the polyether group in at least one of the one or more branched cellulose ethers is a polyoxyalkylene chosen a polyoxyethylene, a polyoxypropylenes and combinations thereof, preferably, a polyoxypropylene.

The branched cellulose ether of the exterior coating compositions and method of using the exterior coating composition of the present invention is a polyoxypropylene group containing hydroxyethyl methylcellulose, or, preferably, a hydroxyethyl methyl cellulose containing polyoxypropylene dioxyethylene ether branched or crosslinks.

In accordance with the exterior coating compositions and method of using the exterior coating composition, the branched cellulose ether is a polyoxypropylene group containing hydroxyethyl methylcellulose, or, preferably, a hydroxyethyl methyl cellulose containing polyoxypropylene dioxyethylene ether branches or crosslinks.

Preferably, the exterior coating compositions and method of using the exterior coating composition has a crossover point as measured by oscillation rheometry of a 1.0 wt. % aqueous solution of at least one of the one or more branched ethers, at which storage modulus (G′) and loss modulus (G″) intersect and are identical, of 1.5 ω or less, the G′ and G″ being measured in Pascal at 20° C. using an Anton Paar MCR 302 (Anton Paar, Graz, AT) equipped with a plate having a 50 mm diameter and a cone having a 1° cone angle and a 0.05 mm flattening of the cone point, and varying the angular frequency (ω) in radians/s in a range of (ω) from 0.1 to 100 with a deformation of 0.5%.

The exterior coating compositions and method of using the exterior coating composition of the present invention contains a loading of at least one of the one or more branched cellulose ethers in the wet coating formulation provides a formulation with viscosity from 100 to 75,000 or preferably 2,000 to 15,000, or even more preferably 3,000 to 10,000 mPa·s as measured at 25° C. with Brookfield viscometer, using a spindle #4, at 60 rpm. The loading of at least one of the one or more branched cellulose ethers in the wet coating formulation provides a formulation is also in a range of 0.1% to 2 wt % and preferably 0.15% to 1.0 wt % based on the total weight of the wet coating formulation.

### DETAILED DESCRIPTION

It has been found that the use of branched cellulose ethers containing polyether groups prepared by reacting with a polyether crosslinker, preferably cellulose ethers containing alkyl ether and hydroxyalkyl groups, significantly improve the resistance to water washout of exterior coating compositions.

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

The numerical ranges disclosed herein include all values from, and including, the lower and upper value. For ranges containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.). Unless stated to the contrary, implicit from the context, or customary in the art, all parts and percentages are based on weight and all test methods are current as of the filing date of this disclosure.

As disclosed herein, the term “composition”, “formulation” or “mixture” refers to a physical blend of different components, which is obtained by mixing simply different components by a physical means. The sum of the percentages by weight of each component in a composition is 100 wt %, based on the total weight of the composition.

As used herein, the term “average particle size” refers to the median particle size or diameter of a distribution of particles as determined for example, by a Multisizer 3 Coulter Counter (Beckman Coulter, Inc., Fullerton, CA) according to the procedure recommended by the manufacturer. The median particle size is defined as the size wherein 50 wt % of the particles in the distribution are smaller than the median particle size and 50 wt % of the particles in the distribution are larger than the median particle size. It is a volume average particle size.

As disclosed herein, “and/or” means “and, or as an alternative”. All ranges include endpoints unless otherwise indicated.

As used herein the term, “aqueous” means that the continuous phase or medium is water and from 0 wt. % to 10 wt. %, based on the weight of the medium, of water-miscible compound(s). Preferably, “aqueous” means water.

As used herein, the term “crossover point” means the angular frequency (ω) as determined by oscillation rheometry, at which the storage modulus (G′) and loss modulus (G″) intersect and are identical, wherein G′ and G″ are measured in Pascal by oscillation rheometry as a function of angular frequency (ω) at 20° C. using an Anton Paar MCR 302 oscillating rheometer (Anton Paar, Graz, AT) equipped with a plate having a 50 mm diameter and a cone having a 1° cone angle and a 0.05 mm flattening of the cone point, varying angular frequency (ω) in radians/s in a range of (ω) from 0.1 to 100 with a deformation of 0.5%. In the rheometry, the analyte cellulose ether or branched cellulose ether is dissolved in water by dispersing 1.0 wt. % of the cellulose ether under shear, on a dry basis, in 99.0 wt. % of water over 1 minute in the water at room temperature with stirring, followed by stirring at 1000 rpm for 10 min, then storing the solution over 24 h in a round glass vessel tightly sealed with a lid and rotated slowly about its longitudinal (horizontal) axis for the full 24 hours.

As used herein, the term “DIN EN” refers to a European Norm version of a German materials specification, published by Beuth Verlag GmbH, Berlin, DE. And, as used herein, the term “DIN” refers to the German language version of the same materials specification.

As used herein, the term “DS” is the mean number of alkyl substituted OH-groups per anhydroglucose unit in a cellulose ether . . . the term “MS” is the mean number of hydroxyalkyl substituted OH-groups per anhydroglucose unit, as determined by the Zeisel method. The term “Zeisel method” refers to the Zeisel Cleavage procedure for determination of MS and DS, see G. Bartelmus and R. Ketterer, Fresenius Zeitschrift fuer Analytische Chemie, Vol. 286 (1977, Springer, Berlin, DE), pages 161 to 190.

As used herein, the term branched cellulose ether means a cellulose ether modified by crosslinking reactions with diepoxy polyethers which, absent the reaction with diepoxy polyethers, would have a viscosity of more than 10,000, preferably more than 20,000 and even more preferably 30,000 mPa·s as measured as a 2 wt. % solution in water using a Haake Rotovisko RV 100 rheometer (Thermo Fisher Scientific, Karlsruhe, DE) at 20° C. and a shear rate 2.55 s⁻¹.

As used herein, the term “washout” is the potential for a coating applied to a surface to be washed out or washed off due to rain or other moisture exposure after a short period of time post application of said coating. Washout is quantified is the amount of reduction in coating applied to a surface as compared to its initial coating amount (e.g., 100% coverage).

As used herein, the term “pigment to binder ratio” or “P/B ratio” is the ratio of the weight of pigment (and fillers) to the weight of binder solids in a coating. This is a measure of the ratio of inorganics to polymer binders in a given composition. The pigment may be inorganic particulate materials which are capable of materially contributing to the opacity or hiding capability of a coating. The fillers are inorganics such as calcium carbonate, silicates, sand, or alumina trihydrate. The pigment to binder ratio value may be calculated if the raw material charges to the coating are known. Alternatively, when the content is unknown, the pigment to binder ratio can be assayed by ash content methods such as ASTM D3723-05 (2017).

As used herein, the term “active weight” is the portion the overall weight of an additive, for example a branched cellulose ether, in a given composition.

Suitable cellulose ethers for use in the methods to make the crosslinked polyether group containing cellulose ethers of the present invention may include, for example, a hydroxyalkyl cellulose or an alkyl cellulose, or a mixture of such cellulose ethers. Examples of cellulose ether compounds suitable for use in the present invention include, for example, methylcellulose (MC), ethyl cellulose, propyl cellulose, butyl cellulose, hydroxyethyl methylcellulose (HEMC), hydroxypropyl methylcellulose (HPMC), hydroxyethyl cellulose (“HEC”), ethylhydroxyethylcellulose (EHEC), methylethylhydroxyethylcellulose (MEHEC), hydrophobically modified ethylhydroxyethylcelluloses (hmEHEC), hydrophobically modified hydroxyethylcelluloses (hmHEC), sulfoethyl methylhydroxyethylcelluloses (SEMHEC), sulfoethyl methylhydroxypropylcelluloses (SEMHPC), and sulfoethyl hydroxyethylcelluloses (SEHEC). Preferably, the cellulose ethers are mixed cellulose ethers that contain hydroxyalkyl groups and alkyl ether groups, such as alkyl hydroxyethyl celluloses, such as hydroxyalkyl methylcelluloses, for example, hydroxyethyl methylcellulose (HEMC), hydroxypropyl methylcellulose (HPMC), methyl hydroxyethyl hydroxypropylcellulose (MHEHPC), methyl hydroxyethylcellulose (MEHEC), and ethylhydroxyethyl cellulose (EHEC).

In the branched cellulose ethers of the present invention, alkyl substitution is described in cellulose ether chemistry by the term “DS”. The DS is the mean number of substituted OH groups per anhydroglucose unit. The methyl substitution may be reported, for example, as DS (methyl) or DS (M). The hydroxy alkyl substitution is described by the term “MS”. The MS is the mean number of moles of etherification reagent which are bound as ether per mol of anhydroglucose unit. Etherification with the etherification reagent ethylene oxide is reported, for example, as MS (hydroxyethyl) or MS (HE). Etherification with the etherification reagent propylene oxide is correspondingly reported as MS (hydroxypropyl) or MS (HP). The side groups are determined using the Zeisel method (reference: G. Bartelmus and R. Ketterer, Fresenius Zeitschrift fuer Analytische Chemie 286 (1977), 161-190).

A branched hydroxyalkyl group containing cellulose ether preferably has a degree of hydroxyalkyl substitution MS (HE) of 1.5 to 4.5, or, more preferably, a degree of substitution MS (HE) of 2.0 to 3.0.

Preferably, mixed ethers of methyl cellulose are used for the crosslinking reactions. In the case of HEMC, a preferred methyl substitution DS (M) values ranges from 1.2 to 2.1 or, more preferably, from 1.3 to 1.7, or, even more preferably, from 1.35 to 1.65, and hydroxyalkyl substitution MS (HE) values range from 0.05 to 0.75, or, more preferably, from 0.10 to 0.45, or, even more preferably, 0.15 to 0.40. In the case of HPMC, preferably, DS (M) values range from 1.2 to 2.1, or, more preferably, from 1.3 to 2.0 and MS (HP) values range from 0.1 to 1.5, or, more preferably, from 0.15 to 1.2.

Crosslinking agents suitable for use in the present invention may include compounds having a polyoxyalkylene or polyalkylene glycol group and two or more, preferably, two crosslinking groups, such as glycidyl or epoxy groups, or ethylenically unsaturated groups, e.g. vinyl groups, that form ether bonds with the cellulose ether in crosslinking the cellulose ether. Suitable bifunctional compounds may be chosen from, for example, diglycidyl polyalkoxy ethers, diglycidyl phosphonate, divinyl polyoxyalkylenes containing a sulphone group. Examples of these are diglycidyl polyoxypropylenes and glycidyl(poly)oxyalkyl methacrylates, preferably, diglycidyl polyalkoxy ethers, e.g. diglycidyl polyoxypropylene; glycidyl(poly)oxyalkyl methacrylate; diglycidyl phosphonates; or divinyl polyoxyalkylenes containing a sulphone group.

The amount of crosslinking agent used may range from 0.0001 to 0.05 eq, where the unit “eq” represents the molar ratio of moles of the respective crosslinking agent relative to the number of moles of anhydroglucose units (AGU) of the cellulose ether. The preferred amount of crosslinking agent used is 0.0005 to 0.01 eq, or, more preferably, the amount of crosslinking agent used is 0.001 to 0.005 eq. As used herein, the unit “eq” represents the molar ratio of moles of the respective crosslinking agent relative to the number of moles of anhydroglucose units (AGU) in the cellulose ether; and, granulating and drying the resulting crosslinked polyether group containing cellulose ether.

Methods for branching the cellulose ethers to make the polyether group containing cellulose ethers of the present invention may comprise reacting crosslinking agents with the cellulose ethers in a reactor in which the cellulose ether itself is made and in the presence of caustic or alkali. Thus, the crosslinking reaction is thus generally conducted in the process of making a cellulose ether. Because the process of making a cellulose ether comprises stepwise addition of reactants to form alkyl or hydroxyalkyl groups on cellulose, preferably, the branching or crosslinking of the cellulose ethers is preceded by (i) one or more addition of alkyl halide, e.g. methyl chloride, in the presence of alkali to form alkyl ethers of the cellulose or (ii) alkylene oxide in the presence of alkali to form hydroxyalkyl groups on the cellulose; or (iii) both (i) and (ii).

Any step in the stepwise addition to form alkyl, hydroxyalkyl or ether groups on cellulose, whether it occurs before, during or after the branching or crosslinking of the cellulose ethers may take place at a temperature of from 40 to 90° C., preferably, 70° C. or less, or, more preferably, 65° C. or less.

So that the cellulose ethers are not degraded or broken down in processing, the branching or crosslinking reaction is carried out in an inert atmosphere and at temperatures of from room temperature to 90° C. or less, or, preferably, at as low a temperature as is practicable; for example, the process preferably is carried out at from 60° C. to 90° C. or, preferably, 70° C. or more.

After the polyether group containing cellulose ethers of the present invention are made, they are granulated and dried. Granulation may follow dewatering or filtering to remove excess water, if needed.

An Aqueous Emulsion of Acrylic Polymer

The aqueous emulsion of acrylic polymer can be prepared through free radical emulsion or suspension polymerization or by dispersion of a pre-formed polymer under shear into an aqueous medium. Monomers suitable for the preparation of the acrylic polymer include, but are not limited to, (meth)acrylic acids and (meth)acrylates, such as alkyl (meth)acrylates. Examples of alkyl (meth)acrylates are, but not limited to, methyl acrylate, ethyl acrylate, butyl acrylate, glycidyl methacrylate, 2-ethylhexyl acrylate, methyl methacrylate, ethyl methacrylate, butyl methacrylate, and 2-ethylhexyl methacrylate, and combinations thereof. The acrylic polymer may comprise, based on the weight of the polymer, from 0% to 10% by weight, from 0.5% to 8% by weight, from 0.8% to 5% by weight, or from 1% to 3% by weight, of structural units of (meth)acrylic acids. The acrylic polymer may comprise, based on the weight of the polymer, from 10% to 100% by weight, from 15% to 99% by weight, from 20% to 95% by weight, from 30% to 80% by weight, or from 40% to 75% by weight, of structural units of alkyl (meth)acrylates.

The acrylic polymer in the present disclosure may comprise structural units of one or more ethylenically unsaturated monomers carrying at least one heterofunctional group. The heterofunctional group may be selected from the group consisting of ureido, nitrile, amide, hydroxyl, alkoxysilane (preferably hydrolyzable alkoxysilane), or phosphorous group.

Preferably, the heterofunctional group may be selected from the group consisting of ureido, nitrile and amide. Suitable ureido functional monomer includes, for example, ureido group containing (meth)acrylic acid alkyl esters. Examples of suitable ureido monomers are illustrated below:

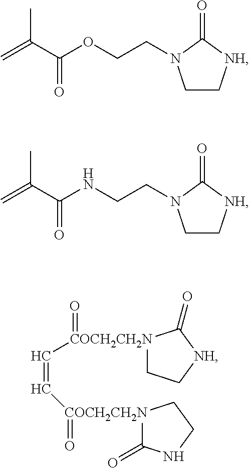

or mixtures thereof. Representative functional monomer like Norsocryl 104 can be obtained from Arkema. Suitable alkoxysilane functional monomer includes, for example, vinyltrialkoxysilanes such as vinyltrimethoxysilane; alkylvinyldialkoxysilanes; (meth)acryloxyalkyltrialkoxysilanes such as (meth)acryloxyethyltrimethoxysilane and (meth)acryloxypropyltrimethoxysilane; derivatives thereof, and combinations thereof. Preferred alkoxysilane functional monomer is Silquest A-171 available from Momentive. Suitable nitrile functional monomer includes, for example, (alkyl)acrylonitrile, such as (meth)acrylonitrile. Suitable amide functional monomer includes, for example, (alkyl)acrylamide, such as (meth)acrylamide. Suitable phosphorous functional monomer includes, for example, phosphorous-containing (meth)acrylates, such as phosphoethyl (meth)acrylate, phosphopropyl (meth)acrylate, phosphobutyl (meth)acrylate, salts thereof, and mixtures thereof; CH₂═C(R)—C(O)—O—(R₁O)ₙ—P(O)(OH)₂, wherein R=H or CH₃, R₁=alkyl, and n=2-6, such as SIPOMER PAM-100, SIPOMER PAM-200, and SIPOMER PAM-300 all available from Solvay; phosphoalkoxy (meth)acrylates such as phospho ethylene glycol (meth)acrylate, phospho di-ethylene glycol (meth)acrylate, phospho triethylene glycol (meth)acrylate, phospho propylene glycol (meth)acrylate, phospho dipropylene glycol (meth)acrylate, phospho tri-propylene glycol (meth)acrylate, salts thereof, and mixtures thereof. Preferred phosphorous-containing (meth)acrylate is ethylene glycol methacrylate phosphate from producers like Hangzhou Hairui Chemical Co., Ltd. Suitable hydroxy functional monomer includes, for example, hydroxyethyl (meth)acrylate and hydroxypropyl (meth)acrylate. The alkyl mentioned above is preferably C1-C10 alkyl, more preferably C1-C6 alkyl, or even more preferably C1-C4 alkyl.

The acrylic polymer may comprise, based on the weight of the polymer, from 0.1% to 20% by weight, from 0.5% to 15% by weight, from 1% to 12% by weight, or from 1.5% to 10%, or from 1.5% to 5%, by weight, of structural units of one or more ethylenically unsaturated monomers carrying at least one heterofunctional group.

The acrylic polymer may further comprise structural units of one or more styrene monomers. The styrene monomers may include, for example, styrene, substituted styrene, or mixtures thereof. The substituted styrene may include, for example, benzyl acrylate, 2-phenoxyethyl acrylate, butylstyrene, methylstyrene, p-methoxystyrene, or mixtures thereof. Preferred styrene monomer is styrene. The polymer may comprise, by weight of the polymer, 1% or more, 5% or more, 10% or more, 15% or more, 17% or more, 19% or more, or even 21% or more, and at the same time, 40% or less, 35% or less, 30% or less, 28% or less, or even 26% or less, of structural unit(s) of the styrene monomer(s).

The polymer useful in the present disclosure may be prepared by free-radical polymerization, preferably emulsion polymerization, of the monomers described above. Emulsion polymerization is a preferred process. Total weight concentration of the monomers for preparing the polymer is equal to 100%. A mixture of the monomers may be added neat or as an emulsion in water; or added in one or more additions or continuously, linearly or nonlinearly, over the reaction period of preparing the polymer. Temperature suitable for emulsion polymerization processes may be lower than 100° C., in the range of from 30 to 95° C., or in the range of from 50 to 90° C.

In one embodiment, the aqueous emulsion of acrylic polymer may include, but is not limited to: PRIMAL™ EC 4642, PRIMAL™ EC 4811, PRIMAL™ EC 2848ER, PRIMAL™ AC261P, PRIMAL™ EC 1791, PRIMAL™ EC 1791QS, and/or TIANBA™ 2012 available from the Dow Chemical Company. Some additional non-limiting ERC grades include: PRIMAL™ EC-5210 PU and PRIMAL™ EC-2885 ER. Some additional non-limiting ETICS grades include: UCAR™ Latex DL 424 and PRIMAL™ WDV-2001. RHOPLEX™ acrylic emulsion polymers may also be utilized amongst other functionally capable compositions.

The acrylic polymer in the present disclosure may have a weight average molecular weight of from 10,000 to 1,000,000, from 20,000 to 700,000, or from 40,000 to 500,000. The weight average molecular weight may be measured by gel permeation chromatography (GPC) calibrated by the polystyrene standard.

The acrylic polymer useful in the present disclosure may have a Fox Tg of −50° C. or higher, −40° C. or higher, −30° C. or higher, −25° C. or higher, or even −20° C. or higher, and at the same time, 30° C. or less, 20° C. or less, 10° C. or less, 0° C. or less, −4° C. or less, or even −5° C. or less. Some preferred embodiments have a Fox Tg of range of −40° C. to 20° C.

The pH of the aqueous emulsion of acrylic polymer in the present disclosure has a pH no higher than 11. Generally, one or more volatile or non-volatile bases can be incorporated in an effective amount to maintain the pH of the composition in the range of from 7.2 to 11 or in the range of from 7.5 to 10.5. In some embodiments, one or more volatile or non-volatile bases can be incorporated in the composition at concentrations of between 0 wt % and 5.0 wt %. In certain embodiments, one or more volatile bases can be incorporated in the composition at concentrations of between 0.1 wt % and 2.5 wt %.

The aqueous emulsion of acrylic polymer may have post added additives for quick drying such as poly-functional amine polymers such as polyethylenimine (PEI).

The aqueous emulsion of acrylic polymer may have a solids content of 30%-70%, or 40%-65% or 45-60% based on the total weight of the aqueous emulsion of acrylic polymer.

The aqueous emulsion of acrylic polymer may have an average particle size ranging from 60 to 800 nm or 80 to 500 nm or preferably 90 to 300 nm.

The emulsion of acrylic polymer may be present in an amount of 5% or more, 10% or more, 15% or more, 20% or more, or even 30% or more, and at the same time, 80% or less, 70% or less, 60% or less, 50% or less, 45% or less, by weight based on the total weight of the coating composition.

Branched Cellulose Ethers

In general, a process for producing a branched cellulose either (BCE) includes an alkalization step and an etherification step. A step of grinding the cellulose starting material can be carried out, and typically desired, prior to the alkalization step; and a washing step and/or a drying/milling step of the BCE can be carried out after the etherification step. During the alkalization operation of the process, a crosslinking agent is introduced or added to the alkalization operation to provide branching or crosslinking of the cellulose material later downstream of the process such as during the etherification operation. Preferably, the crosslinking agent reaction is thus generally conducted in the process of making a cellulose ether.

In one broad embodiment, the present invention relates to crosslinking agent dosage and crosslinking agent addition to a process for producing an BCE product. In one preferred embodiment, the crosslinking agent is added to, or dosed into, the alkalization step or operation of the process combined with an alkalization reagent in the form of a mixture of the crosslinking agent and the alkalization reagent.

The small dosage of crosslinking agent used in the present invention results in an ultra-high viscous product with the same rheological performance as known products (e.g., a high viscosity measured in millipascal seconds [mPa·s] at the standard conditions of 25° C. and 1 atm of pressure) but with a crosslinking agent having a higher efficiency. Advantageously, the result is a reduced level of undesired side reactions and minimum impact on wastewater treatment. Also, in the present invention, the dosage of costly crosslinking agents can be reduced and over crosslinking is prevented.

The crosslinking agent dosage used in the present invention has the benefit of using an alkali/water as a suspension medium (or diluting agent) for the crosslinking agent, so that the objective of providing a uniform distribution of the dispersion in the cellulose material during the dosage step can be achieved more easily compared to conventional processes. In addition, the present invention using the alkali/water suspension medium does not have the safety issues and environmental concerns in a manufacturing plant as do the processes known in the art which use an organic solvent as a diluting agent for a crosslinking agent. Further benefits of the present invention process include, for example, (1) the process uses a readily available crosslinking agent based on diglycidyl ether chemistry such as Epilox M 985 or Epilox P13-42 both are available from Leuna-Harze GmbH; and (2); the crosslinking agent/alkali/water dispersion is non-toxic. In contrast, known processes use epichlorohydrin (ECH) as the crosslinking 5 agent system; and such known processes suffer from several disadvantages, including, for example, ECH is known to be toxic, is a carcinogenic, and has a low boiling point (116° C.)/low molecular weight (Mw) (92.53 g-mol_1).

Such cellulose ethers may include but are not limited to: WALOCEL™ M 120-01.

Other Additives

In addition to the components described above, the coating composition of the present disclosure may further comprise any one or combination of the following additives: pigments, extenders, additional thickeners, defoamers, dispersants, coalescents, and/or cementitious materials (discussed below).

Yet other additives such as buffers, neutralizers, humectants, mildewcides, biocides, wetting agents, colorants, flowing agents, antioxidants, plasticizers, leveling agents, thixotropic agents, adhesion promoters, water retention additives and grind vehicles. When present, these additives may be present in a combined amount of from 0% to 5% by weight or from 0.1% to 3% by weight, or from 0.5% to 1.5% by weight, based on the total weight of the coating composition.

Preferably, the coating composition is selected from an exterior elastomeric roof coating composition, an exterior elastomeric wall coating composition, an exterior coating, or an exterior stucco coating.

Pigments

The coating composition of the present disclosure may also comprise one or more pigments. Pigments may include particulate inorganic materials which are capable of materially contributing to the opacity or hiding capability of a coating. Such materials typically have a refractive index greater than 1.8. Examples of suitable pigments include titanium dioxide (TiO₂), zinc oxide, zinc sulfide, iron oxide, barium sulfate, barium carbonate, or mixtures thereof. The pigments may be present in an amount of zero or more, 0.5% or more, 1% or more, 1.5% or more, or even 2% or more, and at the same time, 20% or less, 15% or less, 10% or less, or even 5% or less, by weight based on the total weight of the coating composition.

Extenders

The coating composition of the present disclosure may comprise one or more extenders. Extenders may include particulate inorganic materials typically having a refractive index of less than or equal to 1.8 and greater than 1.5. Examples of suitable extenders include calcium carbonate, alumina trihydrate, silica, aluminum oxide (Al₂O₃), clay, calcium sulfate, aluminosilicate, silicate, zeolite, mica, sand, diatomaceous earth, solid or hollow glass, ceramic bead, and opaque polymers such as ROPAQUE™ Ultra E available from The Dow Chemical Company (ROPAQUE is a trademark of The Dow Chemical Company), or mixtures thereof. The extenders may be present in an amount of zero or more, 5% or more, 10% or more, 15% or more or even 20% or more, and at the same time, 80% or less, 70% or less, 60% or less, 50% or less, 40% or less, 30% or less, or even 25% or less, by weight based on the total weight of the coating composition.

Additional Thickeners

The coating composition of the present disclosure may comprise one or more thickener (also known as “rheology modifier”). Thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. Preferred thickener is based on HEUR. The thickener may be present in an amount of zero or more, 0.01% or more, or even 0.1% or more, and at the same time, 5% or less, 4% or less, or even 3% or less, by weight based on the total weight of the coating composition.

Defoamers

The coating composition of the present disclosure may comprise one or more defoamer. “Defoamer” herein refers to a chemical additive that reduces and hinders the formation of foam. Defoamers may be silicone-based defoamers, mineral oil-based defoamers, ethylene oxide/propylene oxide-based defoamers, alkyl polyacrylates, or mixtures thereof. Suitable commercially available defoamers include, for example, TEGO Airex 902 W and TEGO Foamex 1488 polyether siloxane copolymer emulsions both available from Evonik, BYK-024 silicone defoamer available from BYK, NOPCO NXZ defoamer available from San Nopco or mixtures thereof. The defoamer may be present in an amount of zero or more, 0.01% or more, or even 0.1% or more, and at the same time, 2% or less, 1.5% or less, or even 1% or less, by weight based on the total weight of the coating composition.

Dispersants

The coating composition of the present disclosure may further comprise one or more dispersants. Suitable examples of the dispersant include non-ionic, anionic and cationic dispersants such as polyacid with suitable molecular weight, 2-amino-2-methyl-1-propanol (AMP), dimethyl amino ethanol (DMAE), potassium tripolyphosphate (KTPP), trisodium polyphosphate (TSPP), citric acid and other carboxylic acids. Preferred dispersants are polyacids, i.e., homopolymers or copolymers of carboxylic acids, hydrophobically or hydrophilically modified polyacids, salts thereof, and any combination thereof. Suitable examples of the hydrophobically or hydrophilically modified polyacids include polyacrylic acid, polymethacrylic acid, and maleic anhydride modified with hydrophilic or hydrophobic monomers such as styrene, acrylate or methacrylate esters, diisobutylene. The molecular weight of such polyacid dispersant is from 400 to 50,000, preferably from 500 to 30,000, more preferably from 1000 to 10,000, and most preferably from 1,500 to 3,000. The dispersant may be present in an amount of zero or more, 0.1% or more, 0.2% or more, or even 0.3% or more, and at the same time, 12% or less, 10% or less, 9% or less, 5% or less, or even 2% or less, by weight based on the total weight of the coating composition.

Coalescents

The coating composition of the present disclosure may comprise one or more coalescent. “Coalescent” herein refer to a slow-evaporating solvent that facilitates diffusion of polymer particles into a continuous film under ambient condition. Suitable coalescents may include, for example, 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include dipropylene glycol n-butyl ether, ethylene glycol monobutyl ether, diethylene glycol monobutyl ether, n-butyl ether, 2,2,4-trimethyl-1,3-pentanediol monoisobutyrate, or mixtures thereof. The coalescent may be present in an amount of zero or more, 0.1% or more, or even 1% or more, and at the same time, 12% or less, 10% or less, or even 9% or less, by weight based on the total weight of the coating composition.

Cementitious Materials

The coating composition of the present disclosure, especially the two-component cementitious waterproofing coating composition may comprise one or more cementitious materials such as cement. Preferably, the cement can be selected from white cement, silicate cement and composite silicate cement. The cementitious materials can be present in an amount of zero or more, 5% or more, 10% or more, or even 15% or more, and at the same time, 50% or less, 40% or less, 30% or less, or even 25% or less, by weight based on the total weight of the coating composition.

Silicone/Silane Additives

Silicone/silane additives may be used to increase water vapor permeance, adhesion promotion, as well as for increasing water contact angle. Examples of such additives include but are not limited to DOWSIL™ IE 6692, DOWSIL™ IE 6683, DOWSIL™ IE 2404, and DOWSIL™ Z 70; DOWSIL™ products are available from the Dow Chemical Company.

Preparation Method

The coating composition of the present disclosure may be prepared with techniques known in the coating art, for example, by admixing the aqueous emulsion of acrylic polymer with other optional components described above. Components in the coating composition may be mixed in a suitable order to provide the coating composition of the present disclosure. Any of the above-mentioned optional components may also be added to the composition during or prior to the mixing to form the coating composition. The coating composition of the present disclosure is an aqueous coating composition.

In some embodiments, branched cellulose ether is premixed with water and propylene glycol. This mixture is then added to an aqueous emulsion of acrylic polymer with other optional components described above.

In some embodiments, the branched cellulose ether is premixed with suitable dry formulation components, such as aggregates used in ETICS, and the mixture of dry ingredients is added to the coating composition.

The present disclosure also provides a method of preparing a coating. The method may comprise forming the coating composition, applying the coating composition to a substrate, and drying, or allowing to dry, the applied coating composition to form the coating. The coating composition can be applied to a substrate by incumbent means including brushing, dipping, rolling and spraying. The coating composition is preferably applied by rolling and spraying. Typical rollers and standard rolling techniques are used. The standard spray techniques and equipment for spraying such as air-atomized spray, air spray, airless spray, high-volume low-pressure spray, and electrostatic spray such as electrostatic bell application, and either manual or automatic methods can be used. After the coating composition has been applied to a substrate, the coating composition can dry, or allow to dry, to form a film (this is, coating). The process can occur exterior ambient temperatures from 5 to 40° C., or at room temperature (20-25° C.), or at an elevated temperature, for example, from 35 to 60° C. The coating composition can provide the coating obtained therefrom (that is, the film obtained after drying, or allowing to dry, the coating composition applied to a substrate).

The coating composition of the present disclosure can be applied to, and adhered to, various substrates. Examples of suitable substrates include concrete, cementitious substrates, woods, metals, stones, elastomeric substrates, glass or fabrics. The coating composition is suitable for various coating applications, such as waterproofing coatings, architecture coatings, marine and protective coatings, automotive coatings, wood coatings including furniture coatings, joinery coatings, and floor coatings, coil coatings, traffic paints, and civil engineering coatings. The coating composition can be used alone, or in combination with other coatings to form multi-layer coatings.

It should be noted the active weight percentage for a given composition (e.g., topcoat or ERC) is the portion of the overall weight of the composition which is a certain additive (e.g., branched cellulose ether).

### Examples

Preparation of Gel-Like Crosslinked Cellulose Ether:

Branched cellulose ether 1 (BCE-1) is a diglycidyl ether modified cellulose ether made from 70% hydroxyethyl methylcellulose and 30% cotton linters, DS (Methyl)=1.57; MS (hydroxyethyl)=0.28; viscosity of product 12690 mPa·s, 1% wt. % aq. solution, shear rate 2.55 s⁻¹, 20° C. (Viscotester VT550 by Thermo Haake); COV=0.5 rad/s (Anton Paar MCR 302, Anton Paar). Cross-over value COV=0.5 rad/s (1 wt. %, Anton Paar MCR 302, Anton Paar, 20° C.).

Crosslinked Cellulose Ether Synthesis:

The branched HEMC cellulose ether was based on 70 wt. % of wood pulp and 30 wt. % of cotton linters and was made in the same manner as described in the experimental part of WO2020223040A1 to Hild et al. (Hild reference) with 0.0013 mmol branching agent/mol AGU (anhydroglucose units) in manner disclosed in the innovation Examples 1 of the Hild reference.

Testing the Coating Compositions:

To test the presently disclosed exterior coating composition and method, Extruded Polystyrene (XPS) panels which represent an exterior surface (e.g., wall, roof, etc.) are coated with a basecoat and then a topcoat. The topcoat mixtures are homogeneously spread over the basecoat using a trowel and at then rubbed with a wetted XPS piece to homogenize the surface. This application is then tested for resistance to early water exposure.

The presently disclosed composition is also tested as an Elastomeric Roof Coating (ERC) wherein the ERC is applied on the XPS panels directly without basecoat. This application is also then tested for resistance to early water exposure.

### I.) Tested Formulations

TABLE 1
A—Chemicals used in Formulations

| Chemical | | | |
|---|---|---|---|
| Description | Product Name | Function | Source |
| Water | N/A | Solvent | Tap Water |
| Polycarboxylic acid | OROTAN | Dispersant | Dow Chemical |
| homopolymer | N-4045 | | |
| Polycarboxylic acid | OROTAN 850 | Dispersant | Dow Chemical |
| homopolymer | | | |
| Silicone-free | BYK-014 | Defoamer | BYK GmbH |
| polymer | | | (Atlanta Group) |
| Polyether-modified | BYK-019 | Defoamer | BYK GmbH |
| polydimethylsiloxane | | | (Atlanta Group) |
| Polysiloxanes and | BYK-024 | Defoamer | BYK GmbH |
| hydrophobic solids | | | (Atlanta Group) |
| in polyglycol | | | |
| Cellulose ether | NATROSOL | Rheology | Ashland |
| | 250 MBR | modifier | |
| Cellulose ether | WALOCEL ™ | Rheology | Dow Chemical |
| | MW 15000 PFV | modifier | |
| Cellulose ether | WALOCEL ™ | Rheology | Dow Chemical |
| | 40000 PFV | modifier | |
| Branched Cellulose | BCE-1 | Rheology | Dow Chemical |
| Ether | | modifier | |
| Ionic acrylate | Acrysol ™ | Rheology | Dow Chemical |
| | ASE 60 ER | modifier | |
| | (28% active) | | |
| Hydrophobically | Acrysol ™ | Rheology | Dow Chemical |
| modified alkali | TT 615 | modifier | |
| swellable polymer | (30% active) | | |
| Aluminium | Portoflame | Fire | Sibelco |
| trihydrate | SG-30 | retarding | |
| | | filler | |
| Calcium carbonate | Omyacarb | Filler | Omya AG |
| | 10-AV | | |
| Calcium carbonate | Omyacarb 40 | Filler | Omya AG |
| Calcium carbonate | Omyacarb 130 | Filler | Omya AG |
| Titanium dioxide | Ti-Pure R-960 | Pigment | Chemours |
| | | | (DuPont) |
| mica/quartz/chlorite | Plastorit 000 | Filler | Imerys |
| Diketopyrrolo | Novaprint | Organic | Chromaflo |
| pyrrole pigment | E RH6 | Colorant | Technologies |
| | | | Corp. |
| Acrylic co-polymer | Primal ™ | Binder | Dow Chemical |
| | WDV 2001 ER | | |
| | Acrylic | | |
| | Dispersion | | |
| | (47% solids) | | |
| Acrylic Polyurethane | Primal ™ | Binder | Dow Chemical |
| dispersion | EC-5210 PU | | |
| | (52.5% solids) | | |
| BIT¹ and MIT² | Rocima MB2X | In-can | International |
| | | preservative | Flavors & |
| | | | Fragrances Inc. |
| DCOIT³ and IPBC⁴ | Bioban 350 PST | Film | International |
| | | preservative | Flavors & |
| | | | Fragrances Inc. |
| Glycol ether | UCAR ™ | Film former | Dow Chemical |
| | Filmer IBT | | |
| Propylene Glycol | Propylene | Co-solvent | Dow Chemical |
| | Glycol | | |
| Calcium carbonate | Omyaper1 | Aggregate | Omya AG |
| | 0.5-1.0 | | |
| Calcium carbonate | Omyaperl | Aggregate | Omya AG |
| | 1.0-1.5 | | |
| SiO₂ | STW ZW gl | Fibers | Schwarzwälder |
| | 5.6-6 mm | | Textil-Werke |
| | | | Heinrich |
| | | | Kautzmann |
| | | | GmbH |
| Cementitious | Jura CEM I, | Hydraulic | Jura-Cement- |
| admixture | 42.5 | binder | Fabriken AG |
| SiO₂ | Quartz Sand, | Aggregate | PCI |
| | F32 | | Bauprodukte AG |
| SiO₂ | Quartz Sand, | Aggregate | PCI |
| | F36 | | Bauprodukte AG |
| Filler, Calcium | Omyacarb 40 | Filler | Omya AG |
| carbonate | | | |
| Redispersabla latex | DLP ™ 210 | Organic | Dow Chemical |
| powder | | binder | |
| Cellulose Ether | Walocel ™ | Rheology | Dow Chemical |
| | MKX 45000 | modifier | |
| | PF 20 L | | |

B—Cellulose Ether Viscosities

| Cellulose Ether | Viscosities | | Concentration |
|---|---|---|---|
| NATROSOL | 4500-6500 | mPa · s | 2% |
| 250 MBR | | | |
| WALOCEL ™ | 16000 | mPa · s | 2% |
| MW 15000 PFV | | | |
| WALOCEL ™ | 35000-45000 | mPa · s | 2% |
| 40000 PFV | | | |
| Branched cellulose | 120000 | mPa · s | 2% |
| ether (BCE-1) | | | |
| Walocel ™ | 40000-50000 | mPa · s | 2% |
| MKX 45000 | | | |
| PF 20 L | | | |

Note:
Data above is from an Ashland Natrosol 20 TDS NR 4739-1. Test performed with Brookfield, spindle #4 and 60 rpm at standard conditions.

TABLE 2
Basecoat Mixture

| Trade name | wt % |
|---|---|
| Jura CEM I, 42.5 | 38 |
| Quarzsand, F32 | 37.25 |
| Quarzsand, F36 | 12 |
| Omyacarb 40 | 10 |
| DLP 210 | 2.5 |
| Walocel ™ MKX | 0.25 |
| 45000_PF 20L | |
| Total | 100 |
| Water | 25 |

TABLE 3
A—Topcoat Comparative Compositions

| Addition | | Comp. | Comp. | Comp. | Comp. |
|---|---|---|---|---|---|
| Order | Component | I | II | III | IV |
| 1 | Water | 8.79 | 8.79 | 8.79 | 8.79 |
| 3 | Orotan N4045 | 0.15 | 0.15 | 0.15 | 0.15 |
| 5 | BYK-014 (100% activ) | 0.21 | 0.21 | 0.21 | 0.21 |
| 12 | Walocel ™ MW 15000 | 0.20 | | | |
| | PFV | | | | |
| 12 | Walocel ™ MW 40000 | | 0.20 | | |
| | PFV | | | | |
| 13 | Acrysol ™ ASE 60 ER | | | 0.72 | |
| | (28% activ) | | | | |
| 13 | Acrysol ™ TT 615 | | | | 0.67 |
| | (30% activ) | | | | |
| 12 | Branched cellulose | | | | |
| | ether (BCE-1) | | | | |
| 8 | Omyacarb 40 | 20.94 | 20.94 | 20.94 | 20.94 |
| 9 | Omyacarb 130 | 11.02 | 11.02 | 11.02 | 11.02 |
| 6 | TiO₂ | 1.46 | 1.46 | 1.46 | 1.46 |
| 7 | Plastorit 000 | 1.04 | 1.04 | 1.04 | 1.04 |
| 10 | Novaprint E RH6 | 2.06 | 2.06 | 2.06 | 2.06 |
| 11 | Primal ™ WDV 2001 | 10.32 | 10.32 | 10.32 | 10.32 |
| | ER (0.465 wt % active) | | | | |
| 4 | UCAR ™ filmer IBT | 0.14 | 0.14 | 0.14 | 0.14 |
| 12 | Omyaperl 0.5-1.0 | 16.51 | 16.51 | 16.51 | 16.51 |
| 12 | Omyaperl 1.0-1.5 | 27.04 | 27.04 | 27.04 | 27.04 |
| 2 | STW ZW gl 5.6-6 mm | 0.10 | 0.10 | 0.10 | 0.10 |

B—Topcoat Inventive Compositions

| Addition | | Inventive | Inventive |
|---|---|---|---|
| Order | Component | Ex. I | Ex. II |
| 1 | Water | 8.79 | 8.79 |
| 3 | Orotan N4045 | 0.15 | 0.15 |
| 5 | BYK-014 (100% activ) | 0.21 | 0.21 |
| 12 | Walocel ™ MW 15000 | | |
| | PFV | | |
| 12 | Walocel ™ MW 40000 | | |
| | PFV | | |
| 13 | Acrysol ™ ASE 60 ER | | |
| | (28% activ) | | |
| 13 | Acrysol ™ TT 615 | | |
| | (30% activ) | | |

| | | | |
|---|---|---|---|
| 12 | Branched cellulose | 0.20 | 0.13 |
| | ether (BCE-1) | | |
| 8 | Omyacarb 40 | 20.94 | 20.94 |
| 9 | Omyacarb 130 | 11.02 | 11.02 |
| 6 | TiO₂ | 1.46 | 1.46 |
| 7 | Plastorit 000 | 1.04 | 1.04 |
| 10 | Novaprint E RH6 | 2.06 | 2.06 |
| 11 | Primal ™ WDV 2001 | 10.32 | 10.32 |
| | ER (0.465 wt % active) | | |
| 4 | UCAR ™ filmer IBT | 0.14 | 0.14 |
| 12 | Omyaperl 0.5-1.0 | 16.51 | 16.51 |
| 12 | Omyaperl 1.0-1.5 | 27.04 | 27.04 |
| 2 | STW ZW gl 5.6-6 mm | 0.10 | 0.10 |

TABLE 4
ERC Formulations

| | | Com- | Com- | In- | In- | In- |
|---|---|---|---|---|---|---|
| | | para- | para- | ven- | ven- | ven- |
| | | tive | tive | tive | tive | tive |
| | | ERC | ERC | ERC | ERC | ERC |
| Addition | | I | II | I | II | III |
| order | Component | (g) | (g) | (g) | (g) | (g) |
| | Grind | | | | | |
| 1 | di-water | 9.48 | 9.47 | 9.48 | 9.49 | 9.50 |
| 2 | Orotan 850 | 0.25 | 0.25 | 0.25 | 0.25 | 0.25 |
| | [30%] | | | | | |
| 3 | BYK 019 | 0.23 | 0.23 | 0.23 | 0.23 | 0.23 |
| 4 | Portoflame | 21.98 | 21.96 | 21.98 | 22.00 | 22.02 |
| | SG-40 | | | | | |
| 5 | Omyacarb | 9.16 | 9.15 | 9.16 | 9.17 | 9.18 |
| | 10-AV | | | | | |
| 6 | Ti-Pure R- | 5.50 | 5.49 | 5.50 | 5.51 | 5.51 |
| | 960 | | | | | |
| | Let Down | | | | | |
| 7 | PRIMAL ™ | 50.26 | 50.22 | 50.26 | 50.32 | 50.35 |
| | EC-5210 | | | | | |
| | PU | | | | | |
| 8 | BYK 024 | 0.09 | 0.09 | 0.09 | 0.09 | 0.09 |
| 9 | UCAR ™ | 0.62 | 0.62 | 0.62 | 0.62 | 0.62 |
| | Filmer IBT | | | | | |
| 10 | Rocima | 0.36 | 0.36 | 0.36 | 0.36 | 0.36 |
| | MB2X | | | | | |
| 11 | Bioban 350 | 0.17 | 0.17 | 0.17 | 0.17 | 0.17 |
| | PST | | | | | |
| | Premix | | | | | |
| 12.1 | Propylene | 1.15 | 1.15 | 1.15 | 1.15 | 1.15 |
| | Glycol | | | | | |
| 12.2 | di-water | 0.39 | 0.39 | 0.39 | 0.39 | 0.39 |
| 12.3 | Natrosol ™ | 0.36 | | | | |
| | 250 MBR | | | | | |
| 12.4 | Branched | | | 0.36 | 0.24 | 0.18 |
| | cellulose | | | | | |
| | ether | | | | | |
| | (BCE-1) | | | | | |
| 12.5 | Acrysol ™ | | 0.44 | | | |
| | ASE-60 | | | | | |
| | Totals | 100.00 | 100.00 | 100.00 | 100.00 | 100.00 |

### II.) Experimental Procedures

Preparation of XPS Panel with Basecoat

The cementitious basecoat is prepared according to DIN EN 12004-2 including the components listed in Table 2. The basecoat is then applied to XPS panels (28×23×2 cm) with a thickness of 3 mm using a trowel. Plastic spacers (280×8×3 mm) are fixed at the long edges of the XPS panel to define the thickness. The basecoated panels are then dried at 23° C. and 50% relative humidity for at least 48 hours.

### Topcoat Preparation

The topcoat (organic renders) are prepared by adding the different components listed in Table 3 in the addition order as indicated in Table 3. Components 1-5 are added with a container (0.8-1.3 L) directly placed on the balance with short manual agitation between each component. The mixture is then mixed using a Dispermat F105 device at 800 rpm. The radius of the container is at minimum double the radius of the mixer blade to ensure proper mixing. Components 6-10 are then added while stirring over 5-10 minutes. The mixture is then stirred for an additional 10 minutes at 800 rpm. The rotation speed is then reduced to 400 rpm before the acrylic binder is slowly added (component 11). After 5 minutes of mixing the dry premix of components 12 are added and mixing continues for another 5-10 minutes depending on the thickener that was added. The premix of components 12 is prepared by adding all dry ingredients to a container and blending them with a Turbula Unit T2C dry mixer. This is critical to homogeneously add the cellulose ether thickeners and prevent lump formation. The pigment to binder ratio of the topcoat is 16.3 to 1.

### ERC Coating Preparation

ERC formulation is prepared according to the formulation Table 4. The grind is prepared in a stainless-steel grind pot. The ingredients are combined in the order lists and then mixed at high speed for 20 minutes. The mixing speed is reduced to maintain a vortex and the ingredients of the letdown are added in the order listed. In a separate container, the premix ingredients are combined and then added to the grind pot. Mixing is continued for 10 minutes with sufficient agitation to maintain a vortex. The pigment to binder ratio of the ERC coating is 1.4 to 1.

### ERC Coating Application

The coating is applied on the XPS panel substrate directly without a basecoat. The application is performed by a Zehntner gap applicator with gap size of 1 mm. The applied width is 12 cm. The coated panels are cured at 23° C. and 50% for 3 hours before the early water test.

### Early Water Test of ERC Coating

After conditioning, the samples are positioned in front of a water spray nozzle (Kärcher stainless steel nozzle 17CA, 1.1 L/Min) at a distance of 30 cm. Water is sprayed with a controlled pressure of 2 bars for 3 min. The panels are then dried at 23° C. and 50% relative humidity before pictures are taken.

### Early Water Test of Topcoat

The topcoat mixtures are homogeneously spread over the basecoat using a trowel and then rubbed with a wetted XPS piece to homogenize the surface. The thickness of the topcoat is defined by the size of the large aggregates formed. The panels are then dried under controlled conditions and a given time (see the results section). A Voetsch Climate Chamber is used to dry the panels in a challenging environment (e.g, at least 75% relative humidity and 7° C. for 7 h).

After the defined drying period, the samples are positioned in front of a water spray nozzle (Karcher stainless steel nozzle 17CA, 1.1 L/Min) at a distance of 30 cm. Water is sprayed with a controlled pressure of 2 bars for 15 min. The panels are then dried at 23° C. and 50% relative humidity before photos are taken (180 dpi, Canon PowerShot SX200 IS, RGB).

### Image Processing

Photos of the panels are analyzed with the GIMP 2.10.22 software. The uncovered areas were manually marked white and the covered area red. After merging the red and white layers to a new image, the percentage of coverage was extracted on the basis of the binary histogram for that image for each panel (resolution of a pixel).

### III.) Results

Table 5 and Table 6 below show the percentage of area where basecoat and topcoat aggregates remain on a given XPS panel after the early water test. A higher percentage of covered area indicates that the formulation shows better early water resistance. As shown in Table 5, the cure conditions for the given coatings are challenging and meant to represent application in a high humidity/rainy environment. The samples shown in Table 5 were cured at 7° C., 76% relative humidity, and a 7-hour drying time. The samples shown in Table 6 were cured in ambient conditions of 23° C., 50% relative humidity, 3 hour drying time.

The comparative samples in Tables 5 and 6 feature the use of conventional CE rheology modifiers and synthetic rheology modifiers, added at the same active level. The presently disclosed compositions are compared at the same or reduced active concentration in the formulation.

TABLE 5
Basecoat/Topcoat Render Performance at High Humidity

| | | Active | Covered area |
|---|---|---|---|
| | | addition | after ERR test |
| Sample | Thickener type | Wt % | Area % |
| Comparative I | Cellulose ether | 0.2 | 70 |
| | rheology modifier | | |
| | (Walocel ™ 15000) | | |
| Comparative II | Cellulose ether | 0.2 | 72 |
| | rheology modifier | | |
| | (Walocel ™ 40000) | | |
| Comparative III | Synthetic rheology | 0.2 | 27 |
| | modifier (ASE 60) | | |
| Comparative IV | Synthetic rheology | 0.2 | 30 |
| | modifier (TT 615) | | |
| Inventive Ex. I | Branched cellulose | 0.2 | 95 |
| | ether (BCE-1) | | |
| Inventive Ex. II | Branched cellulose | 0.13 | 99 |
| | ether (BCE-1) | | |

TABLE 6
Basecoat/Topcoat Render Performance in Ambient Conditions

| | | Active | Covered area |
|---|---|---|---|
| | | addition | after ERR test |
| Sample | Thickener type | Wt % | Area % |
| Comparative I | Cellulose ether | 0.2 | 75 |
| | rheology modifier | | |
| | (Walocel ™ 15000) | | |
| Comparative II | Cellulose ether | 0.2 | 68 |
| | rheology modifier | | |
| | (Walocel ™ 40000) | | |
| Comparative III | Synthetic rheology | 0.2 | 48 |
| | modifier (ASE 60) | | |
| Inventive Ex. I | Branched cellulose | 0.2 | 90 |
| | ether (BCE-1) | | |
| Inventive Ex. II | Branched cellulose | 0.13 | 84 |
| | ether (BCE-1) | | |

Table 7 shows the percentage of area where ERC remains on a given XPS panel after the early water test. The ERC formulation was applied to an XPS panel without basecoat and then cured at 23° C., 50% relative humidity, and a 3-hour drying time. The coated and dried XPS panels are then washed with water at around 29 PSI (2 bars) of pressure for 3 minutes. Tables 8-10 show the various physical properties of the tested ERC and comparative ERCs.

TABLE 7
ERC Formulation Results

| | | Active | Covered area |
|---|---|---|---|
| | | addition | after ERR test |
| Sample | Thickener type | Wt % | Area % |
| Comparative | 250 MBR | 0.36 | 32 |
| ERC I | | | |
| Comparative | Synthetic rheology | 0.12 | 32 |
| ERC II | modifier (ASE 60) | | |
| Inventive | Branched cellulose | 0.36 | 94 |
| ERC I | ether (BCE-1) | | |
| Inventive | Branched cellulose | 0.24 | 85 |
| ERC II | ether (BCE-1) | | |
| Inventive | Branched cellulose | 0.18 | 53 |
| ERC III | ether (BCE-1) | | |

TABLE 8
ERC Formulation Water Absorption Results

| | | Active | Water |
|---|---|---|---|
| | | addition | absorption, |
| Sample | Thickener type | Wt % | 7 days, % |
| Comparative | 250 MBR | 0.36 | 8.8 |
| ERC I | | | |
| Comparative | Synthetic rheology modifier | 0.12 | 15.7 |
| ERC II | (ASE 60) | | |
| Inventive | Branched cellulose ether | 0.36 | 7.4 |
| ERC I | (BCE-1) | | |
| Inventive | Branched cellulose ether | 0.24 | 7.5 |
| ERC II | (BCE-1) | | |
| Inventive | Branched cellulose ether | 0.18 | 7.4 |
| ERC III | (BCE-1) | | |

TABLE 9
ERC Formulation Elongation at Break Results

| | | Active | Elongation |
|---|---|---|---|
| | | addition | at |
| Sample | Thickener type | Wt % | break, % |
| Comparative | 250 MBR | 0.36 | 193 |
| ERC I | | | |
| Comparative | Synthetic rheology modifier | 0.12 | 223 |
| ERC II | (ASE 60) | | |
| Inventive | Branched cellulose ether | 0.36 | 171 |
| ERC I | (BCE-1) | | |
| Inventive | Branched cellulose ether | 0.24 | 178 |
| ERC II | (BCE-1) | | |
| Inventive | Branched cellulose ether | 0.18 | 192 |
| ERC III | (BCE-1) | | |

TABLE 10
ERC Formulation Tensile Strength at Maximum

| | | Active | Tensile |
|---|---|---|---|
| | | addition | strength, |
| Sample | Thickener type | Wt % | [MPa] |
| Comparative | 250 MBR | 0.36 | 2.20 |
| ERC I | | | |
| Comparative | Synthetic rheology modifier | 0.12 | 2.30 |
| ERC II | (ASE 60) | | |
| Inventive | Branched cellulose ether | 0.36 | 2.35 |
| ERC I | (BCE-1) | | |
| Inventive | Branched cellulose ether | 0.24 | 2.51 |
| ERC II | (BCE-1) | | |
| Inventive | Branched cellulose ether | 0.18 | 2.41 |
| ERC III | (BCE-1) | | |

### IV.) Analysis.

The results show a clear improvement in early water resistance of the branched cellulose ether compared to synthetic or conventional CEs. Under challenging conditions (Table 5) the area of coverage remains above 90% while conventional CEs give an area of coverage of approximately 70%. Synthetic thickeners perform much worse with an area of coverage of only 30%. This clear improvement was also obtained after only 3 hours drying under ambient conditions (Table 6).

There is also a clear improvement for an ERC made using the branched cellulose ether. As shown in Table 7, the covered area remaining after the early water test is over double (close to triple) the coverage area seen with conventional CEs and synthetic thickeners. The percentage of water absorption after is also better for all tested inventive examples versus the conventional CEs and synthetic thickeners (Table 8). Tables 9 and 10 show that an ERC produced by using the branch cellulose ether also exhibits similar elongation capability and tensile strength as traditional ERCs.

1. An exterior coating composition, comprising:
a) an aqueous emulsion of acrylic polymers, and
b) at least one branched cellulose ether, wherein the branched cellulose ether has a viscosity of at least 6000 mPa·s in a 1% wt. % aqueous solution with a shear rate of 2.55 s⁻¹ at 20° C. and an active addition weight percentage of 0.1% to 2.0% of the exterior coating composition.

2. The composition of claim 1, wherein the branched cellulose ether has a viscosity of at least 10000 mPa·s in a 1% wt. % aqueous solution with a shear rate of 2.55 s⁻¹ at 20° C.

3. The composition of claim 1, wherein the composition further includes at least one pigment and at least one binder.

4. The composition of claim 3, wherein pigment to binder ratio is 16.3 to 1.

5. The composition of claim 3, wherein pigment to binder ratio is 1.4 to 1.

6. The composition of claim 1, wherein the active addition weight percentage of the at least one branched cellulose ether is from 0.13% to 0.5% of the exterior coating composition.

7. An exterior coating formed from the composition of claim 1, wherein the composition is applied upon a substrate.

8. A method of coating an exterior surface, comprising:
a) applying a basecoat on the exterior surface and allowing the basecoat to dry for at least 48 hours, and
b) applying a topcoat homogeneously over the basecoat, wherein the topcoat comprises an aqueous emulsion of acrylic polymer and at least one branched cellulose ether, wherein the branched cellulose ether has a viscosity of at least 6000 mPa·s in a 1% wt. % aqueous solution with a shear rate of 2.55 s⁻¹ at 20° C. and an active addition weight percentage of 0.1% to 2.0% of the topcoat.

9. The method of claim 8, wherein the topcoat is applied at a temperature of 7° C. to 25° C. and at least 75% relative humidity.

10. The method of claim 8, wherein the active addition weight percentage of the at least one branched cellulose ether is from 0.13% to 0.2% of the topcoat.
